(19) United States
(12) Patent Application Publication
(10) Pub. No.: US 2026/0309884 A1
(43) Pub. Date: Oct. 8, 2026

(54) CLUSTER EFFICIENCY EVALUATION USING STRAIN OBSERVATION FROM A MONITORING WELL

(71) Applicant: Schlumberger Technology Corporation, Sugar Land, TX (US)

(72) Inventors: Dmitry Sergeevich Kuznetsov, Sugar Land, TX (US); Roman Vladimirovich Korkin, Sugar Land, TX (US); Mikhail Kaznacheev, Sugar Land, TX (US); Anna Zhirkina, Sugar Land, TX (US); Joel Herve Le Calvez, Sugar Land, TX (US)

(21) Appl. No.: 19/632,965

(22) Filed: Mar. 30, 2026

Related U.S. Application Data
(60) Provisional application No. 63/784,388, filed on Apr. 7, 2025.

(51) Int. Cl. G01V 1/42; G01L 1/24

(52) U.S. Cl. CPC G01V 1/42; G01L 1/242; G01V 2200/16; G01V 2210/6169; G01V 2210/66

(57) ABSTRACT

A comprehensive methodological framework for monitoring hydraulic fracturing operations utilizing the surface and/or downhole pumping data (with pressure, rate and proppant concentration), fracture growth model from a fracture simulator coupled with low-frequency strain data acquired via Distributed Acoustic Sensing (DAS) technology.

### CROSS-REFERENCE TO RELATED APPLICATIONS

The present application claims priority to United States Provisional Application 63/784,388 dated Apr. 7, 2025, the entirety of which is incorporated by reference.

### FIELD OF THE DISCLOSURE

Aspects of the disclosure relate to monitoring well observations. More specifically, aspects of the disclosure relate to distributed acoustic sensing and mathematical models to characterize strain propagation through a formation.

### BACKGROUND

Hydraulic fracturing is a well stimulation process that is used to produce hydrocarbons from wellbores. These wellbores may have differing geological characteristics. One such characteristic that many wellbores have that undergo hydraulic fracturing is that the wellbores have a generally low permeability. Hydraulic fracturing may be used in other instances as well. Hydraulic fracturing may be used to fracture geological formation in attempts to create a geothermal system. Hydraulic fracturing involves the high pressure of injection of fluids into a wellbore or stratum, wherein the pressure is of sufficient strength to break or crack the formation. Materials may be added to the fluid to enable the cracks to be held open after the cessation of pumping from the surface. The materials may include various types of materials including sand and/or glass beads. In addition to the above, chemicals may be added to the fluid stream to provide for cleaning/lubricating the cracks and to start a flow of hydrocarbons. The creation of the cracks within the formation causes a difference in pressure through which the hydrocarbons pass from higher to lower pressure.

Hydraulic fracturing may be accomplished in different types of wellbores. These different types of wellbores may include vertical, horizontal or combination vertical and horizontal. More than one hydraulic fracturing may occur in one wellbore. In some instances, a series of hydraulic fracturing treatments may be performed along the wellbore such that different areas may be fractured. Such methodologies are generally defined as multi-stage fracturing. Within such operational frameworks, a significant technical challenge designated as “FracHit” may manifest when newly hydraulically-induced fractures intersect previously stimulated zones or adjacent wellbore structures. FracHit phenomena are associated with production interference mechanisms, wellbore structural integrity compromise, and diminished recovery efficiencies, thereby representing substantial economic detriment.

Real-time monitoring of fracture networks propagation parameters has become a critical operational requirement for optimization of hydraulic fracturing treatments and mitigation of FracHit occurrences. Established monitoring methodologies include microseismic monitoring systems, tiltmeter arrays, and pressure monitoring protocols, each exhibiting inherent limitations regarding spatial and temporal resolution capabilities, sensitivity thresholds, or deployment constraints.

Downhole monitoring is critical for maximizing efficiency of hydraulic fracturing operations. One such monitoring technique, Distributed Acoustic Sensing (DAS) technology has emerged as a viable methodological approach for downhole monitoring applications. DAS implementation utilizes fiber optic cable to quantify strain variations along the entirety of the fiber length via analysis of backscattered light resultant from laser pulse transmission, effectively establishing numerous sensing points with high spatial and temporal resolution parameters. While DAS applications have traditionally centered on high-frequency acoustic events (>10 Hz), recent technological advancements have facilitated the measurement of low-frequency strain data (<10 Hz). Said low-frequency components encompass critical information regarding quasi-static deformation characteristics of subsurface formations resultant from hydraulic stimulation operations.

There is a need to provide an apparatus and methods that allow for monitoring of geological conditions that are easy.

There is a further need to provide apparatus and methods that do not have the drawbacks discussed above, such as preventing FracHit conditions.

There is a still further need to reduce economic costs associated with operations and apparatus described above with conventional tools and methods such that evaluations are quickly and economically completed.

### SUMMARY

So that the manner in which the above recited features of the present disclosure can be understood in detail, a more particular description of the disclosure, briefly summarized below, may be had by reference to embodiments, some of which are illustrated in the drawings. It is to be noted that the drawings illustrate only typical embodiments of this disclosure and are therefore not to be considered limiting of its scope, for the disclosure may admit to other equally effective embodiments without specific recitation. Accordingly, the following summary provides just a few aspects of the description and should not be used to limit the described embodiments to a single concept.

In one non-limiting embodiment, a method for evaluating and optimizing cluster efficiency in a hydraulic fracturing operation is disclosed. The method may comprise (a) simulating a plurality of hydraulically stimulated fracture scenarios using at least one analytical or semi-analytical models using data from at least one formation and stimulation parameters of interest. The method may further comprise (b) generating, for each simulated scenario, a predicted strain signal over time using a strain rate simulation model, wherein a strain is calculated for a fiber-optic cable disposed in an offset monitoring well matching a real case monitoring geometry. The method may further comprise (c) identifying, for each scenario, a first detectable signal appearance time tᵢ at which the simulated distributed acoustic sensing signal becomes visible in the offset well. The method may further comprise (d) initiating a hydraulic fracturing treatment job and acquiring real-time distributed acoustic sensing data from the monitoring well. The method may further comprise (e) determining a real-time signal appearance time t* in the acquired distributed acoustic sensing data. The method may further comprise (f) comparing t* to a set of first detectable signal appearance times {tᵢ} to select at least one best-matching scenario. The method may further comprise (g) selecting a primary matching scenario as a reference case for ongoing monitoring. The method may further comprise (h) updating the reference case in real-time based on a comparison between the ongoing distributed acoustic sensing data and predicted strain profiles of the selected scenarios. The method may further comprise (i) generating an output indicating a most probable cluster efficiency configuration and corresponding hydraulically-induced fracture development parameters, including uncertainty quantification of these parameters.

In another example embodiment, a system for evaluating cluster efficiency in a hydraulic fracturing operation is disclosed. The system may comprise (a) a modeling module configured to simulate hydraulic fracture propagation under a plurality of cluster configurations. The system may also comprise (b) a strain simulation engine configured to predict distributed acoustic sensing strain signals for each configuration. The system may also comprise (c) a signal monitoring module configured to acquire real-time distributed acoustic sensing data from an offset well. The system may also comprise (d) a data transfer protocol to ensure all data are transferred in real-time. The system may also comprise (e) a system enabling all data to interact. The system may also comprise (f) a pattern recognition module configured to identify a matching simulated scenario based on real-time signal data. The system may also comprise (g) a decision engine configured to determine fracture growth characteristics and recommend optimal cluster efficiency based on matching results.

In another example embodiment, a computer-readable medium storing instructions which, when executed by one or more processors, cause a system to perform a method for evaluating and optimizing cluster efficiency in a hydraulic fracturing operation is disclosed. The method of the computer-readable medium comprising: (a) simulating a plurality of hydraulically stimulated fracture scenarios using at least one analytical or semi-analytical model using data from the formations and stimulation parameters of interest. The method of the computer-readable medium further comprising (b) generating, for each simulated scenario, a predicted strain signal over time using a strain rate simulation model, wherein a strain is calculated for a fiber-optic cable disposed in an offset monitoring well matching a real case monitoring geometry. The method of the computer-readable medium further comprising (c) identifying, for each scenario, a first detectable signal appearance time tᵢ at which the simulated distributed acoustic sensing signal becomes visible in the offset monitoring well. The method of the computer-readable medium further comprising (d) initiating a hydraulic fracturing treatment job and acquiring real-time distributed acoustic sensing data from the monitoring well. The method of the computer-readable medium further comprising (e) determining a real-time signal appearance time t* in the acquired distributed acoustic sensing data. The method of the computer-readable medium further comprising (f) comparing t* to a set of simulated times {tᵢ} to select one or more best-matching scenarios. The method of the computer-readable medium further comprising (g) selecting a primary matching scenario as a reference case for ongoing monitoring. The method of the computer-readable medium further comprising (h) updating the reference case in real-time based on a comparison between the ongoing distributed acoustic sensing data and predicted strain profiles of the selected scenarios. The method of the computer-readable medium further comprising (i) generating an output indicating a most probable cluster efficiency configuration and corresponding hydraulically-induced fracture development parameters, including uncertainty quantification of these parameters.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the drawings. It is to be noted; however, that the appended drawings illustrate only typical embodiments of this disclosure and are therefore, not be considered limiting of its scope, for the disclosure may admit to other equally effective embodiments.

FIG. 1 is an illustration of treatment and monitoring wells which are located 200 m apart, with a fracture angled at 90 degrees to the well. Fracture lengths vary from 30 m to 150 m, depending on the number of active clusters, while the total rate is kept the same and is equally divided between active clusters. The rate through inactive clusters is zero.

FIG. 2 is a graph of strains versus measured depth coordinates for different scenarios at a given time moment (50 mins).

FIG. 3 is a graph of strains versus measured depth coordinates for different scenarios with time. Three vertical lines indicate time moments when signal exceeds the pre-defined thresholds for these scenarios. Scenario 1-6 active clusters, scenario 2-3 active clusters, scenario 3-2 active clusters, scenario 4-1 active cluster.

FIG. 4 is an example method in one non-limiting example embodiment of the disclosure.

To facilitate understanding, identical reference numerals have been used, where possible, to designate identical elements that are common to the figures (“FIGS.”). It is contemplated that elements disclosed in one embodiment may be beneficially utilized on other embodiments without specific recitation.

### DETAILED DESCRIPTION

In the following, reference is made to embodiments of the disclosure. It should be understood; however, that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments and advantages are merely illustrative and are not considered elements or limitations of the claims except where explicitly recited in a claim. Likewise, reference to “the disclosure” shall not be construed as a generalization of inventive subject matter disclosed herein and should not be considered to be an element or limitation of the claims except where explicitly recited in a claim.

Although the terms first, second, third, etc., may be used herein to describe various elements, components, regions, layers, and/or sections, these elements, components, regions, layers, and/or sections should not be limited by these terms. These terms may be only used to distinguish one element, components, region, layer, or section from another region, layer, or section. Terms such as “first”, “second”, and other numerical terms, when used herein, do not imply a sequence or order unless clearly indicated by the context. Thus, a first element, component, region, layer, or section discussed herein could be termed a second element, component, region, layer, or section without departing from the teachings of the example embodiments.

When an element or layer is referred to as being “on”, “engaged to”, “connected to”, or “coupled to” another element or layer, it may be directly on, engaged, connected to, or coupled to the other element or layer, or interleaving elements or layers may be present. In contrast, when an element is referred to as being “directly on”, “directly engaged to”, “directly connected to”, or “directly coupled to” another element or layer, there may be no interleaving elements or layers present. Other words used to describe the relationship between elements should be interpreted in a like fashion. As used herein, the term “and/or” includes any and all combinations of one or more of the associated listed terms.

Some embodiments will now be described with reference to the figures. Like elements in the various figures will be referenced with like numbers for consistency. In the following description, numerous details are set forth to provide an understanding of various embodiments and/or features. It will be understood; however, by those skilled in the art, that some embodiments may be practiced without many of these details, and that numerous variations or modifications from the described embodiments are possible. As used herein, the terms “above” and “below”, “up” and “down”, “upper” and “lower”, “upwardly” and “downwardly”, and other like terms indicating relative positions above or below a given point are used in this description to more clearly describe certain embodiments.

Embodiments of the disclosure may provide for an article of manufacture that contains a non-transitory memory product. The non-transitory memory product may be configured to retain data, such as method steps. The non-transitory memory product may store data and be read by a device. Such devices may be computing devices such as a laptop computer, main frame computer, computer, cell phone or other similar device. The method steps may be used, for example, to control a computer or perform mathematical calculations. In turn, the computer may instruct other systems, machines or components. Example non-transitory memory products may include universal serial bus devices, solid state memory arrangements, compact discs or computer hard drives. In some instances, the non-transitory device may be configured with a device that reads the stored information and transmits the data to a separate location. In some embodiments, artificial intelligence may be used in conjunction with the data stored on the article of manufacture to perform various functions.

Further embodiments may include methodologies that allow computers to be trained to allow for more comprehensive and accurate answers. Such training may be performed in nodes that may be used to allow for fine tuning of results. Upon retention of results of calculations, the method steps may be altered such that results that are not accurate are precluded from future calculations by amending method steps accomplished in various nodes. Such alterations are contemplated and are within the scope of this disclosure.

Aspects of the disclosure introduce a comprehensive methodological framework for monitoring hydraulic fracturing operations utilizing the surface and/or downhole pumping data (with pressure, rate and proppant concentration). In addition, a fracture growth model from a fracture simulator coupled with low-frequency strain data acquired via DAS technology is provided. This framework encompasses the development of a mathematical model characterizing strain propagation in media containing hydraulic fractures and the implementation of novel inversion workflows to determine fracture parameters from measured DAS data, the surface data, and the fracture simulator model. Aspects of the disclosure may be performed on a computing device located at the wellbore or may be located at a remote location.

The process initiates with the formulation of a forward model that predicts strain field distributions surrounding hydraulically-induced fractures with defined dimensional and orientational parameters. The model incorporates the mechanical properties of reservoir lithology and the spatial relationship between hydraulically-induced fracture geometry and fiber optic sensing apparatus placement.

Existing fractures (natural or induced) present in the media of interest (formation) could also be included if the existing fracture characteristics are well known and/or assumed. In this way, the modeling may present an overall configuration of an anticipated state of the formation based upon hydraulic fracturing to be conducted.

While the mathematical modeling of strain propagation constitutes a requisite component, aspects of the present disclosure provide in specialized inversion workflows that determine hydraulically-induced fracture parameters from observed DAS data. The inversion methodology is specifically engineered to overcome the fact that the inverse problem is inherently ill-posed, wherein multiple hydraulically-induced fracture parameter configurations may produce substantially identical strain patterns at observation points. As will be further understood, methodology steps described may identify strain patterns throughout the analysis area so that fracture patterns may be anticipated throughout the model.

Further aspects of the present disclosure use inversion methods that allow cluster efficiency determination using strain observations from a monitoring well coupled with the hydraulically-induced fracture growth model and possibly additional models. The methods enable reliable estimation of hydraulically-induced fracture geometric and physical properties (constrained by the pumping and geological data) in the presence of signal noise and incomplete data acquisition scenarios. The inversion methods include uncertainty quantification providing statistical characteristics of estimated fracture properties. As will be further understood, use of a monitoring well within a stratum may be optional as the modeling may or may not include such a monitoring well. Likewise; however, creation of a field located monitoring well may be used to verify the presence of the hydraulic fracturing and model accuracy.

As will be understood, well observations may indicate the presence of hydraulic fracturing cracks, “FracHit”, that has already happened. These observations may indicate distinct strain rate signals associated with the fractures identified and can help to further narrow down the number of possible scenarios that are present in the model to reduce overall uncertainty.

The model utilizes analytical and/or semi-analytical hydraulic fracture propagation models to simulate a finite set of perforated cluster efficiency configurations. Cluster efficiency herein refers to the relative capacity of distinct perforation clusters within a cased horizontal wellbore to accept slurry volumes during hydraulic stimulation. Each stage typically contains between three and ten clusters, most commonly five, with an inter-cluster spacing of approximately 15 to 50 feet. At the outset, at least one simulation with a baseline scenario of uniformly distributed flow across all clusters is performed. After this simulation, discrete variations are iterated for flow distributions by applying 5 percent incremental adjustments relative to the total surface pump flow rate. For a stage with two clusters, this requires preparing the following flow rate distribution scenarios between the first and second clusters: 100/0 percent, 95/5 percent, 90/10 percent, . . . , down to 0/100 percent. As will be understood, various hydraulic fracturing models such as a Perkins-Kern-Nordgren (PKN) model may be used. Other types of models may include Kristianovich-Geertsma-de Klerk (KGD) or pseudo-3D modeling (P3D).

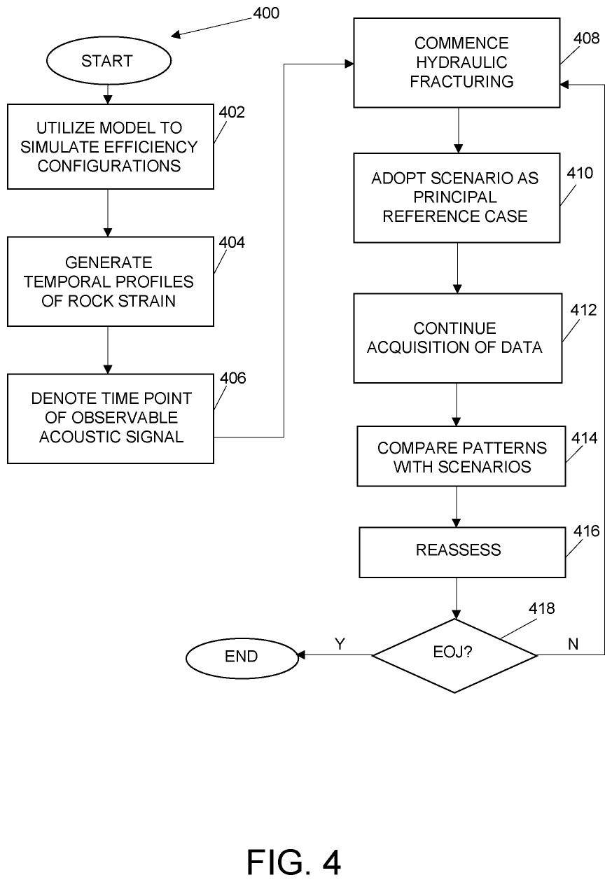

In embodiments, a specific algorithm for the fractures network parameters determination is presented using the fracture growth model, PRC data and strain/strain rate data from an optical cable. Aspects of the method are presented in FIG. 4, that will be described in a step wise fashion. As will be understood, alterations of the methodology presented in FIG. 4, are contemplated; therefore, the method steps may be altered from what is illustrated and described.

### Measurement Methodology

### Simulation of Hydraulic Fracture Propagation Scenarios

Referring to FIG. 4, a method 400 according to one example embodiment of the disclosure is presented. At 402, the method initiates with utilizing analytical or semi-analytical hydraulic fracture propagation models (e.g., PKN, KGD, P3D) to simulate a finite set of perforated cluster efficiency configurations. Cluster efficiency, as defined herein, refers to the relative capacity of distinct perforation clusters within a cased horizontal wellbore to accept slurry volumes during hydraulic stimulation. Each stage typically contains between three and ten clusters, most commonly five, with an inter-cluster spacing of approximately 5 to 15 feet. As will be understood, variations of these numbers and values may occur. Simulations are started with a baseline scenario of uniformly distributed flow across all clusters. Subsequently, discrete variations in flow distribution are iterated, employing a 5 percent (as an example) incremental adjustment relative to the total surface pump flow rate.

### Strain Rate Modeling

At 404, for each scenario generated in 402, a forward-modeling simulation is executed using a Strain Rate Simulation (SRS) tool. One objective of 404 is to generate temporal profiles of reservoir rock strain. In the produced outputs, the x-axis represents time, the y-axis corresponds to either lateral length or measured depth (MD), and color mapping reflects the intensity of the distributed acoustic sensing (DAS) signal. The simulation at 402, calculates strain responses as detected by a fiber-optic cable installed in a monitoring (offset) well located at a defined distance from the treatment well undergoing active hydraulic stimulation/fracturing.

Detection of Signal Higher than Threshold (tᵢ)

At 406. for each simulated scenario, the earliest time point is denoted at tᵢ, denoted as tᵢ (where i=1, 2, . . . , n, and n is the total number of scenarios), at which a discernible and reliable acoustic signal is expected to be observable (i.e., show value above a predefined threshold) from the monitoring (offset) well. This yields a set of several distinct time points corresponding to the various treatment scenarios and serves as a reference database for real-time signal identification. The threshold for a signal to be deemed discernible may be defined individually for each project, using a Strain Rate Simulation (SRS) engine and known parameters, such as distance between wells, total pumping rate and medium properties.

### Field Execution and Real-Time Signal Matching

At 408, the method 400 continues with commencing the actual hydraulic fracturing operation on the wellsite. Concurrently with the above, an acquisition of low-frequency DAS data from the monitoring well is initiated. A time point t* is identified at which a strong and clear signal first becomes visible in the live DAS feed. The most appropriate match(es) from the pre-simulated scenario database are matched for which t*≈tᵢ. Scenarios exhibiting strong temporal and spatial correlation are given special attention. In embodiments, no fewer than one and no more than three, for example, are provided chosen for further analysis. The matching scenarios are denoted as i, j, and k, respectively in one non-limiting example. If there are several possible scenarios, all of the scenarios are saved and analyzed later when new data are gathered. Finally, the set of possible scenarios should reduce, resulting in lowering uncertainty.

### Scenario Selection for Monitoring Continuation

At 410, the method 400 proceeds with adopting a scenario (i) as the principal reference case. Concurrently, scenarios j and k are maintained as secondary reference paths for comparative validation throughout the operation.

### Ongoing DAS Data Acquisition (FBE)

At 412, the method 400 continues with continuing acquisition of real-time DAS data. This is referred to hereafter as Frequency Band Extracted (FBE), for the duration of the treatment stage.

### Pattern Matching and Scenario Validation

At 414, the method 400 continues with comparing the evolving real-time FBE patterns with those of the pre-selected scenarios (i, j, k). In this step, the method determines which scenario demonstrates the highest degree of correlation. As an analytical output, the most probable cluster efficiency scenario and corresponding fracture growth evolution is presented. Additional scenarios that, while less probable, retain a non-negligible likelihood of validity, may also be presented as supplementary hypotheses. For selected scenarios, uncertainty quantification is conducted and displayed to the end-user. Uncertainty quantification includes, but is not limited to, carrying out multiple inversions with a 5 percent variation in fracture properties around the assessed solution to evaluate sensitivity to signal-to-noise ratio, carrying out inversions with alternative physical models (PKN, KGD, P3D, etc.) to assess sensitivity to particular model selection, carrying out inversions with variation in input properties such as formation properties, slurry and pumping rates, etc. if corresponding measurement errors of these parameters are known/assessed.

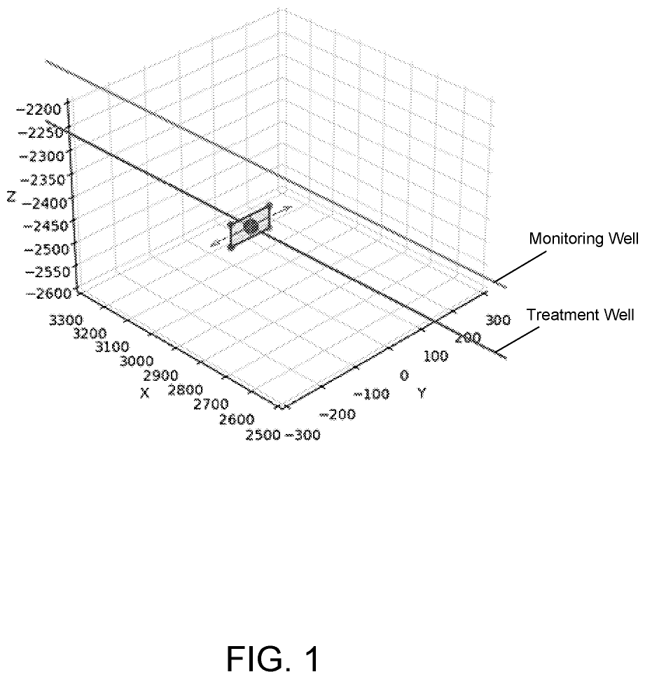

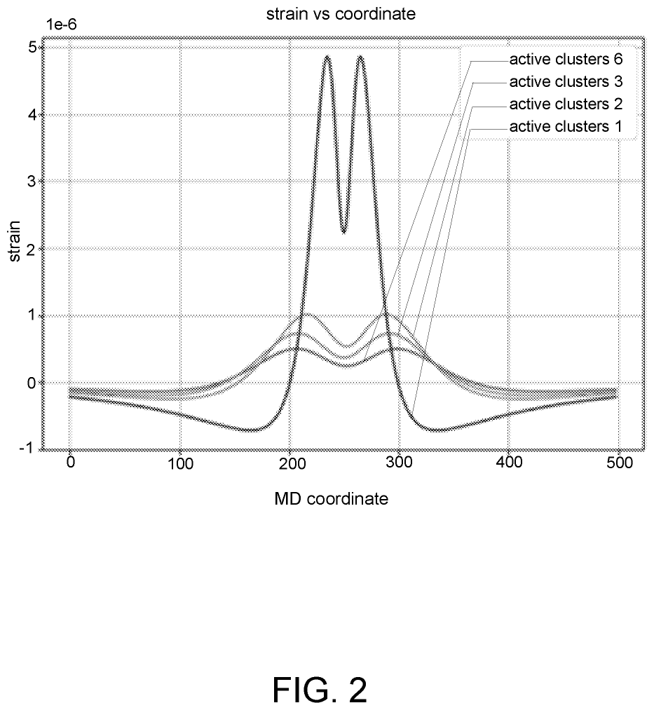

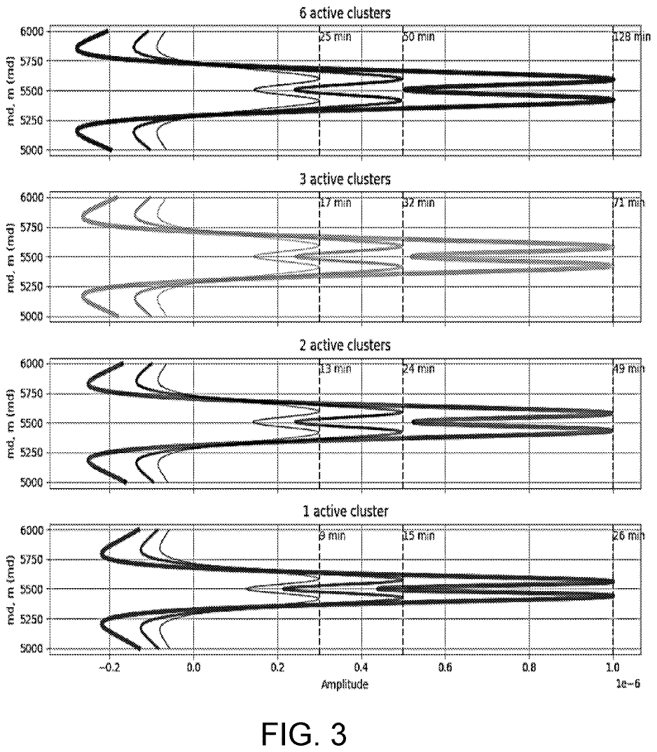

Referring to FIGS. 1-3, examples shown are two horizontal wells, 200 m apart, are presented. Six clusters are presented with fractures that are orthogonal to the wells. Four scenarios are analyzed with the same total rate, but different rate versus clusters distribution (from 6 to 1 active clusters with equal rates, all others-zeros). Lengths and widths follow a PKN model and vary from 30 m to 150 m depending on the number of active clusters.

### Dynamic Scenario Re-Evaluation

At 416, the method 400 continues wherein should the correlation between live DAS data and the current primary scenario (i) diminish, a dynamic reassessment may be initiated. Transition to scenario j or k as appropriate may be performed, selecting the scenario demonstrating superior pattern alignment at that time. This reassessment may occur as needed throughout the treatment operation to preserve the highest model-data fidelity.

### Additional Data

In addition to the strain data dynamic change and fracture grow model, the additional data might be used. One of such data is the use of an additional model, predicting the non-dimensional slurry distribution, the neural network-based model, which uses PRC data and predicts cluster rates nonuniformity:

$$nsd = 1 - \frac{σ}{μ \sqrt{n}} ,$$

where μ, σ are the mean and standard deviation of a cluster's rate, n is the total number of clusters.

### Iterative Monitoring and Scenario Matching Until End of Job (EOJ)

At 418, the method 400 may continue wherein continuous monitoring and model-data matching is maintained throughout the entire duration of the hydraulic fracturing operation. Repeat steps 408 through 418 iteratively until the end of the job (EOJ) is formally declared.

### Final Reporting and Visualization

Upon completion of the treatment, at 420, the method 400 may generate and deliver a comprehensive visualization and summary of the most probable fracture growth scenario (i). This deliverable shall include parameters of fracture propagation and an animated representation of the final scenario, as inferred from the full-cycle model-data comparison process.

Examples of the methods described above may also be directed to a non-transitory computer-readable medium storing computer-executable instructions and executable by one or more processors of the computer via which the computer-readable medium is accessed. A computer-readable media may be any available media that may be accessed by a computer. By way of example, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

The software implemented aspects of the subject matter claimed below are usually encoded on some form of program storage medium or implemented over some type of transmission medium. The program storage medium is a non-transitory medium and may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The claimed subject matter is not limited by these aspects of any given implementation.

In one embodiment, a system or method for evaluating and optimizing cluster efficiency in a hydraulic fracturing operation includes; (a) simulating a plurality of hydraulically-stimulated fracture scenarios using one or more analytical or semi-analytical models using data from the formations and stimulation parameters of interest; (b) generating, for each simulated scenario, a predicted strain signal over time using a strain rate simulation (SRS) model, wherein the strain is calculated for a fiber-optic cable disposed in an offset monitoring well matching the real case monitoring geometry; (c) identifying, for each scenario, a first detectable signal appearance time tᵢ at which the simulated distributed acoustic sensing (DAS) signal becomes visible in the offset well, for example, based on a pre-defined threshold value; (d) initiating a hydraulic fracturing treatment job and acquiring real-time DAS data from the monitoring well; (e) determining a real-time signal appearance time t* in the acquired DAS data; (f) comparing t* to the set of simulated times {tᵢ} to select one or more best-matching scenarios; (g) selecting a primary matching scenario as a reference case for ongoing monitoring; (h) updating the reference case in real-time based on a comparison between the ongoing DAS data and predicted strain profiles of the selected scenarios; and (i) generating an output indicating a most probable cluster efficiency configuration and corresponding hydraulically-induced fracture development parameters, including uncertainty quantification of these parameters. Step (a) may include iteratively varying cluster flow distribution parameters in 5 percent (for example) increments to generate the plurality of simulated scenarios required. The offset monitoring well may include a permanently or temporarily deployed fiber-optic cable. The simulated strain signal is mapped to a color scale indicating signal intensity as a function of time and measured depth (e.g., waterfall plot, etc.). The best-matching scenario/scenarios is/are selected based on both temporal correlation and spatial pattern alignment.

The FracHit event, should it happen, is used to further lower the uncertainty of a fracture geometry and cluster flow distribution. Uncertainty of fracture development parameters is quantified. The output includes an animation visualizing the inferred hydraulically-induced fracture development over time. The system or method may include switching among multiple pseudo-matched scenarios during treatment to maintain the highest correlation fidelity possible. Real-time decisions regarding treatment progression are made based on the identified appropriate matching scenarios.

Example embodiments of the claims are described next. These example embodiments should not be considered limiting. In one non-limiting embodiment, a method for evaluating and optimizing cluster efficiency in a hydraulic fracturing operation is disclosed. The method may comprise (a) simulating a plurality of hydraulically-stimulated fracture scenarios using at least one analytical or semi-analytical models using data from at least one formation and stimulation parameters of interest. The method may further comprise (b) generating, for each simulated scenario, a predicted strain signal over time using a strain rate simulation model, wherein a strain is calculated for a fiber-optic cable disposed in an offset monitoring well matching a real case monitoring geometry. The method may further comprise (c) identifying, for each scenario, a first detectable signal appearance time tᵢ at which the simulated distributed acoustic sensing signal becomes visible in the offset well. The method may further comprise (d) initiating a hydraulic fracturing treatment job and acquiring real-time distributed acoustic sensing data from the monitoring well. The method may further comprise (e) determining a real-time signal appearance time t* in the acquired distributed acoustic sensing data. The method may further comprise (f) comparing t* to a set of first detectable signal appearance times {tᵢ} to select at least one best-matching scenario. The method may further comprise (g) selecting a primary matching scenario as a reference case for ongoing monitoring. The method may further comprise (h) updating the reference case in real time based on a comparison between the ongoing distributed acoustic sensing data and predicted strain profiles of the selected scenarios. The method may further comprise (i) generating an output indicating a most probable cluster efficiency configuration and corresponding hydraulically-induced fracture development parameters, including uncertainty quantification of these parameters.

In another example embodiment, the method may be performed wherein step (a) includes iteratively varying cluster flow distribution parameters in 5 percent increments to generate the plurality of simulated scenarios required.

In another example embodiment, the method may be performed wherein the offset monitoring well comprises a permanently or temporarily deployed fiber-optic cable.

In another example embodiment, the method may be performed wherein the simulated strain signal is mapped to a color scale indicating signal intensity as a function of time and measured depth.

In another example embodiment, the method may be performed wherein the at least one best-matching scenario is selected based on both a temporal correlation and a spatial pattern alignment.

In another example embodiment, the method may be performed wherein a FracHit event is used to lower an uncertainty of a fracture geometry and cluster flow distribution.

In another example embodiment, the method may further comprise quantifying an uncertainty of fracture development parameters.

In another example embodiment, the method may be performed wherein the output includes visual depiction of an animation visualizing hydraulically-induced fracture development over time.

In another example embodiment, the method may further comprise switching among multiple pseudo-matched scenarios during treatment to maintain a highest correlation fidelity possible.

In another example embodiment, the method may be performed wherein real-time decisions regarding treatment progression are made based on the identified appropriate matching scenarios.

In another example embodiment, the method may be performed wherein the output includes visual depiction of an animation visualizing hydraulically-induced fracture development over time.

In another example embodiment, the method may further comprise switching among multiple pseudo-matched scenarios during treatment to maintain a highest correlation fidelity possible.

In another example embodiment, the method may be performed wherein real-time decisions regarding treatment progression are made based on the identified appropriate matching scenarios.

In another example embodiment, the method may further comprise storing the output in a non-volatile memory system.

In another example embodiment, the method may further comprise performing iterative steps in the method for different fracture scenarios.

In another example embodiment, the method may be performed wherein the determining the real-time signal appearance time is through one of visual observation and sensor observation.

In another example embodiment, the method may be performed wherein the simulating the plurality of hydraulically-stimulated fracture scenarios is performed at a remote location from a location of the hydraulic fracturing job.

In another example embodiment, the method may be performed wherein the data from at least one formation and stimulation parameters of interest is obtained from data previously obtained at the geographic location.

In another example embodiment, a system for evaluating cluster efficiency in a hydraulic fracturing operation is disclosed. The system may comprise (a) a modeling module configured to simulate hydraulic fracture propagation under a plurality of cluster configurations. The system may also comprise (b) a strain simulation engine configured to predict distributed acoustic sensing strain signals for each configuration. The system may also comprise (c) a signal monitoring module configured to acquire real-time distributed acoustic sensing data from an offset well. The system may also comprise (d) a data transfer protocol to ensure all data are transferred in real-time. The system may also comprise (e) a system enabling all data to interact. The system may also comprise (f) a pattern recognition module configured to identify a matching simulated scenario based on real-time signal data. The system may also comprise (g) a decision engine configured to determine fracture growth characteristics and recommend optimal cluster efficiency based on matching results.

In another example embodiment, a computer-readable medium storing instructions which, when executed by one or more processors, cause a system to perform a method for evaluating and optimizing cluster efficiency in a hydraulic fracturing operation is disclosed. The method of the computer-readable medium comprising: (a) simulating a plurality of hydraulically-stimulated fracture scenarios using at least one analytical or semi-analytical model using data from the formations and stimulation parameters of interest. The method of the computer-readable medium further comprising (b) generating, for each simulated scenario, a predicted strain signal over time using a strain rate simulation model, wherein a strain is calculated for a fiber-optic cable disposed in an offset monitoring well matching a real case monitoring geometry. The method of the computer-readable medium further comprising (c) identifying, for each scenario, a first detectable signal appearance time tᵢ at which the simulated distributed acoustic sensing signal becomes visible in the offset monitoring well. The method of the computer-readable medium further comprising (d) initiating a hydraulic fracturing treatment job and acquiring real-time distributed acoustic sensing data from the monitoring well. The method of the computer-readable medium further comprising (e) determining a real-time signal appearance time t* in the acquired distributed acoustic sensing data. The method of the computer-readable medium further comprising (f) comparing t* to a set of simulated times {tᵢ} to select one or more best-matching scenarios. The method of the computer-readable medium further comprising (g) selecting a primary matching scenario as a reference case for ongoing monitoring. The method of the computer-readable medium further comprising (h) updating the reference case in real-time based on a comparison between the ongoing distributed acoustic sensing data and predicted strain profiles of the selected scenarios. The method of the computer-readable medium further comprising (i) generating an output indicating a most probable cluster efficiency configuration and corresponding hydraulically-induced fracture development parameters, including uncertainty quantification of these parameters.

In another example embodiment, the computer readable medium may be configured wherein the strain rate simulation model is configured to incorporate a layered reservoir structure including natural fractures and geological faults, thereby enhancing the accuracy of predicted strain responses.

In another example embodiment, the computer readable medium may be configured wherein the hydraulic fracture simulation in Step (a) is performed using a model or a more advanced numerical simulator capable of modeling complex fracture geometries, fluid leak-off, and stress shadow effects.

In another example embodiment, the computer readable medium may be configured wherein the medium is of a form of a compact disk, a solid-state drive, a non-volatile memory system and a universal serial bus device.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may be varied in many ways. Such variations are not to be regarded as a departure from the disclosure, and all such modifications are intended to be included within the scope of the disclosure.

While embodiments have been described herein, those skilled in the art, having benefit of this disclosure, will appreciate that other embodiments are envisioned that do not depart from the inventive scope. Accordingly, the scope of the present claims or any subsequent claims shall not be unduly limited by the description of the embodiments described herein.

What is claimed is:

1. A method for evaluating and optimizing cluster efficiency in a hydraulic fracturing operation, comprising:
(a) simulating a plurality of hydraulically-stimulated fracture scenarios using at least one analytical or semi-analytical model using data from at least one formation and stimulation parameters of interest;
(b) generating, for each simulated scenario, a predicted strain signal over time using a strain rate simulation model, wherein a strain is calculated for a fiber-optic cable disposed in an offset monitoring well matching a real case monitoring geometry;
(c) identifying, for each scenario, a first detectable signal appearance time tᵢ at which the simulated distributed acoustic sensing signal becomes visible in the offset well;
(d) initiating a hydraulic fracturing treatment job and acquiring real-time distributed acoustic sensing data from the monitoring well;
(e) determining a real-time signal appearance time t* in the acquired distributed acoustic sensing data;
(f) comparing t* to a set of first detectable signal appearance times {tᵢ} to select at least one best-matching scenario;
(g) selecting a primary matching scenario as a reference case for ongoing monitoring;
(h) updating the reference case in real-time based on a comparison between the ongoing distributed acoustic sensing data and predicted strain profiles of the selected scenarios; and
(i) generating an output indicating a most probable cluster efficiency configuration and corresponding hydraulically-induced fracture development parameters, including uncertainty quantification of these parameters.

2. The method according to claim 1, wherein step (a) includes iteratively varying cluster flow distribution parameters in 5 percent increments to generate the plurality of simulated scenarios required.

3. The method according to claim 1, wherein the offset monitoring well comprises a permanently or temporarily deployed fiber-optic cable.

4. The method according to claim 1, wherein the simulated strain signal is mapped to a color scale indicating signal intensity as a function of time and measured depth.

5. The method according to claim 1, wherein the at least one best-matching scenario is selected based on both a temporal correlation and a spatial pattern alignment.

6. The method according to claim 1, wherein a FracHit event is used to lower an uncertainty of a fracture geometry and cluster flow distribution.

7. The method according to claim 1, further comprising quantifying an uncertainty of fracture development parameters.

8. The method according to claim 1, wherein the output includes visual depiction of an animation visualizing hydraulically-induced fracture development over time.

9. The method according to claim 1, further comprising switching among multiple pseudo-matched scenarios during treatment to maintain a highest correlation fidelity possible.

10. The method according to claim 1, wherein real-time decisions regarding treatment progression are made based on the identified appropriate matching scenarios.

11. The method according to claim 1, further comprising storing the output in a non-volatile memory system.

12. The method according to claim 1, further comprising performing iterative steps in the method for different fracture scenarios.

13. The method according to claim 1, wherein the determining the real-time signal appearance time is through one of visual observation and sensor observation.

14. The method according to claim 1, wherein the simulating the plurality of hydraulically-stimulated fracture scenarios is performed at a remote location from a location of the hydraulic fracturing job.

15. The method according to claim 1, wherein the data from at least one formation and stimulation parameters of interest is obtained from data previously obtained at the geographic location.

16. A system for evaluating cluster efficiency in a hydraulic fracturing operation, comprising:
(a) a modeling module configured to simulate hydraulic fracture propagation under a plurality of cluster configurations;
(b) a strain simulation engine configured to predict distributed acoustic sensing strain signals for each configuration;
(c) a signal monitoring module configured to acquire real-time distributed acoustic sensing data from an offset well;
(d) a data transfer protocol to ensure all data are transferred in real-time;
(e) a system enabling all data to interact;
(f) a pattern recognition module configured to identify a matching simulated scenario based on real-time signal data; and
(g) a decision engine configured to determine fracture growth characteristics and recommend optimal cluster efficiency based on matching results.

17. A computer-readable medium storing instructions which, when executed by one or more processors, cause a system to perform a method for evaluating and optimizing cluster efficiency in a hydraulic fracturing operation, the method comprising:
(a) simulating a plurality of hydraulically-stimulated fracture scenarios using at least one analytical or semi-analytical model using data from the formations and stimulation parameters of interest;
(b) generating, for each simulated scenario, a predicted strain signal over time using a strain rate simulation model, wherein a strain is calculated for a fiber-optic cable disposed in an offset monitoring well matching a real case monitoring geometry;
(c) identifying, for each scenario, a first detectable signal appearance time tᵢ at which the simulated distributed acoustic sensing signal becomes visible in the offset monitoring well;
(d) initiating a hydraulic fracturing treatment job and acquiring real-time distributed acoustic sensing data from the monitoring well;
(e) determining a real-time signal appearance time t* in the acquired distributed acoustic sensing data;
(f) comparing t* to a set of simulated times {tᵢ} to select one or more best-matching scenarios;
(g) selecting a primary matching scenario as a reference case for ongoing monitoring;
(h) updating the reference case in real-time based on a comparison between the ongoing distributed acoustic sensing data and predicted strain profiles of the selected scenarios; and
(i) generating an output indicating a most probable cluster efficiency configuration and corresponding hydraulically-induced fracture development parameters, including uncertainty quantification of these parameters.

18. The computer readable medium according to claim 17, wherein the strain rate simulation model is configured to incorporate a layered reservoir structure including natural fractures and geological faults, thereby enhancing the accuracy of predicted strain responses.

19. The computer readable medium according to claim 17, wherein the hydraulic fracture simulation in Step (a) is performed using a model or a more advanced numerical simulator capable of modeling complex fracture geometries, fluid leak-off, and stress shadow effects.

20. The computer readable medium according to claim 17, wherein the medium is of a form of a compact disk, a solid-state drive, a non-volatile memory system and a universal serial bus device.
